(19) United States
(12) Patent Application Publication
(10) Pub. No.: US 2017/0237823 A1
(43) Pub. Date: Aug. 17, 2017

(54) SYSTEM AND METHOD FOR TRANSFORMING ONLINE CONTENT

(71) Applicant: BLOCKTHROUGH INC., Toronto (CA)

(72) Inventor: Chris PYPER, Brampton (CA)

(21) Appl. No.: 15/371,342

(22) Filed: Dec. 7, 2016

Related U.S. Application Data
(60) Provisional application No. 62/263,825, filed on Dec. 7, 2015.

(51) Int. Cl. H04L 29/08; H04L 29/12

(52) U.S. Cl. CPC H04L 67/2823; H04L 61/1511; H04L 67/02

(57) ABSTRACT

A system and method for transforming online content transforming online content between a web server and an end-user computing device is provided. The system includes a transformation server comprising one or more processors and a data storage device communicatively linked to the one or more processors, the one or more processors executable to receive online content from the web server; transform portions of the online content to obfuscate supplemental content from primary content; and transmit the online content having the transformed portions to the end-user computing device.

### TECHNICAL FIELD

The following relates generally to content delivery. In particular, the following relates to a system and method for transforming online content.

### SUMMARY

In one aspect, there is provided a system for transforming online content between one or more web servers and an end-user computing device, the online content including primary content and supplemental content, the system including: a transformation server including one or more processors and a data storage device communicatively linked to the one or more processors, the one or more processors executable to: receive online content hosted by the one or more web servers; transform portions of the online content to obfuscate the inclusion of supplemental content among the primary content; and transmit the online content having the transformed portions to the end-user computing device.

In a certain case, the transformation server is a proxy intermediating communication between the web server and the end-user computing device.

In a further case, a Domain Name System (DNS) resolves a domain name of the web server hosting the supplemental content to that of the transformation server.

In another case, the transformation server is executed on at least one of the one or more web servers.

In yet another case, the transforming of portions of the online content includes transforming a Uniform Resource Locator (URL) of the supplemental content to appear to originate from within a selected domain.

In yet another case, the selected domain is a same or similar domain of the primary content.

In yet another case, the selected domain is a domain that is determined by the transformation server to be not contained on a blacklist of advertisement providers.

In yet another case, the transformed URL is generated to be unique for each subsequent transformation.

In yet another case, the transforming of portions of the online content includes transforming aspects of the HyperText Markup Language (HTML) elements or Cascading Style Sheet (CSS) elements of the supplemental content to confound identification of the supplemental content.

In yet another case, wherein the transforming of the HTML elements or CSS elements includes obfuscating HTML identifiers or CSS identifiers unique to the supplemental content.

In yet another case, the transforming of the HTML elements or CSS elements is unique for each subsequent transformation.

In yet another case, the transforming of portions of the online content further includes injecting additional visually-neutral HTML elements or CSS elements into the online content to confound identification of the supplemental content.

In yet another case, the transforming of portions of the online content further includes transforming aspects of the HTML elements or CSS elements of the primary content to confound identification of the supplemental content from the primary content.

In a further case, the transforming of portions of the online content includes bundling supplemental content with resources required to visually render the primary content.

In a further case, the one or more processors are further executable to: map the transformed portions of the online content to the respective portions of the online content prior to transformation; store the transformed portions of the online content; receive a request from the end-user computing device for at least one of the said portions of the online content; and use the mappings, retrieving the transformed portions of the online content corresponding to the requested portions of the online content.

In yet another case, the transforming of portions of the online content includes injecting additional supplemental content from an alternate source.

In yet another case, communication with the transformation server is initiated by a JavaScript file in the header of the online content.

In another aspect, there is provided a method for transforming online content between a web server and an end-user computing device, the online content including primary content and supplemental content, the method including: receiving online content from the web server; transforming transform portions of the online content to obfuscate the inclusion of supplemental content among the primary content; and transmitting the online content having the transformed portions to the end-user computing device.

In a certain case, the transforming of portions of the online content includes transforming a Uniform Resource Locator (URL) of the supplemental content to appear to originate from within a selected domain.

In another case, the selected domain is a same or similar domain of the primary content.

In yet another case, the selected domain is a domain that is determined to be not contained on a blacklist of advertisement providers.

In yet another case, the transformed URL is generated to be unique for each subsequent transformation.

In yet another case, the transforming of portions of the online content includes transforming aspects of the HyperText Markup Language (HTML) elements or Cascading Style Sheet (CSS) elements of the supplemental content to confound identification of the supplemental content.

In yet another case, the transforming of portions of the online content further includes injecting additional visually-neutral HTML elements or CSS elements into the online content to confound identification of the supplemental content.

In yet another case, the transforming of portions of the online content includes bundling supplemental content with resources required to visually render the primary content

In yet another case, the transforming of portions of the online content includes injecting additional supplemental content from an alternate source.

In yet another case, communication with the transformation server is initiated by a JavaScript file in the header of the online content.

In another case, the method further includes: mapping the transformed portions of the online content to the respective portions of the online content prior to transformation; storing the transformed portions of the online content; receiving a request from the end-user computing device for at least one of the said portions of the online content; and using the mappings, retrieving the transformed portions of the online content corresponding to the requested portions of the online content.

These and other aspects are contemplated and described herein. It will be appreciated that the foregoing summary sets out representative aspects of a system for transforming online content to assist skilled readers in understanding the following detailed description.

### BRIEF DESCRIPTION OF THE DRAWINGS

A greater understanding of the embodiments will be had with reference to the Figures, in which:

FIG. 1 shows a system for transforming online content, namely a transformation server, and its working environment in accordance with one embodiment thereof;

FIG. 2 is a schematic diagram of the transformation server of FIG. 1;

FIG. 3 is a flowchart of the method of transforming online content used by the system of FIG. 1;

FIG. 4 shows another system for transforming online content and its working environment, in accordance with another embodiment thereof; and

FIG. 5 shows a further system for transforming online content and its working environment, in accordance with a further embodiment thereof.

### DETAILED DESCRIPTION

For simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

Various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender; “exemplary” should be understood as “illustrative” or “exemplifying” and not necessarily as “preferred” over other embodiments. Further definitions for terms may be set out herein; these may apply to prior and subsequent instances of those terms, as will be understood from a reading of the present description.

Any module, unit, component, server, computer, terminal, engine or device exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The following provides a system and method for transforming online content. The described system comprises a server computer system configured to transform portions of a webpage to obfuscate the inclusion of supplemental content within the webpage. By transforming portions of the webpage, the detection of the supplemental content within the webpage is hindered.

Internet content publishers rely upon access to services outside their domains to supplement the content they serve (hereinafter, “primary content”) with scripts and additional content (hereinafter, “supplemental content”) that are used to publish online advertisements and interact with web analytics packages to track web and application traffic. The primary content and the supplemental content are collectively referred to as online content herein, as both are accessed online over a computer network. The primary content, including scripts, are requested and downloaded by an end-user's computing device (hereinafter, “end-user device”) from the Internet content publisher's server (hereinafter, “primary server”), then parsed and executed on the end-user device. An “end-user device” is any computing device that can access such content over the computer network using an application such as a web browser (such as Internet Explorer, Firefox, Safari, Chrome, etc.), or using another application containing a web browser window. Examples of end-user devices include, for example, desktop computers, laptop computers, tablet computers, mobile phones, etc. that are configured to communicate with the primary server and the one or more supplemental servers over the computer network. The parsed primary content specifies the inclusion of supplemental content, tracking content, and/or web analytics packages. Subsequent requests are made to one or more advertiser/ad network servers, web analytics provider servers and metrics provider servers (hereinafter, “supplemental servers”) for supplemental content specified for inclusion in the primary content. The supplemental content can include, for example, advertisement content such as images and text, scripts, as well as tracking content and scripts for web analytics packages.

Primary content can be a webpage or web application, or portions thereof, built using web programming languages like hypertext markup language (“HTML”), cascading style sheets (“CSS”), JavaScript, and a variety of other web programming languages and frameworks. A webpage generally includes a base HTML document that can reference other resources, such as style sheets, images, scripts, etc. for inclusion when generated by a web server or parsed by a web browser or the like for rendering on an end-user device. As used herein, “webpage” may refer to the base HTML document for the webpage or web application, and may also include other primary content and the supplemental content referenced directly or indirectly by the base HTML for the webpage or web application.

The principal server of the Internet content publisher that provides the primary content is a Hypertext Transfer Protocol (“HTTP”) server. An HTTP server is a computer system or an application that assembles webpages and web applications or portions thereof and serves that content to end-users over the internet using HTTP. A publisher is anyone who creates this webpage or application and makes it available to one or more end-user devices over a computer network.

Recently, a number of companies have developed so-called ad blockers (e.g., AdBlock Plus, AdBlock Pro, etc.) and privacy-protecting online supplemental content blockers, which are collectively referred to herein as “blocking tools”. These blocking tools are principally designed to block ad content from being displayed on a webpage retrieved from a publisher's website and presented on an end-user device. Some blocking tools (e.g., uBlock, Ghostery, etc.) also block the functionality of certain web analytics packages (e.g., Google Analytics, Optimizely, etc.), as well as the tracking functionality of certain ad content (e.g. third-party cookies).

Blocking tools can take a number of forms, including:
software installed on the end-user device (e.g., web browsers, browser extensions, and web browser windows embedded in other applications);
Virtual Private Networks (“VPN”) and proxy servers: these are software and services through which requests from the end-user device pass; and
Domain Name Service (“DNS”)-based blocking services, which remap requests for supplemental content from end-user devices to domains or IP addresses which do not respond with the requested supplemental content.

All of these blocking tools block ad content and web analytics packages using one of more of the following mechanisms: domain-based blocking, CSS selector-based blocking, and JavaScript-based blocking.

Most blocking tools work primarily by blocking requests to the servers of known or suspected advertising networks, tracking networks, and web analytics providers. To do this, they identify requests for content that appears to reside in an Internet domain belonging to one of the aforementioned, and then block or prevent server calls in instances where the uniform resource locator (“URL”) of the content being requested meets one or both of the following criteria:
the URL contains an Internet domain belonging to a publicly- or privately-maintained “blacklist” of known ad providers (e.g. http://www.knownadprovider.com);
the URL contains a specific keyword that would indicate that the content being served might be ad content (e.g. http://www.adnetwork.com contains the keyword ‘ad’, and content from there would be blocked); and
the URL contains or resolves to a particular IP address that appears on a publicly- or privately-maintained blacklist of known ad providers.

Certain blocking tools can also transform downloaded content to hide or block ads, web analytics packages, or other content based on certain attributes. They do this by matching the HTML attributes of content, such as class, id, style, etc. on elements within the page, to certain criteria on publicly-maintained blacklists or certain keywords. Once matched, these specific elements are made invisible by various approaches, such as setting the CSS “display” property in the webpage delivered to the end-user device to “none” or removing the HTML element from the webpage.

Some browser extension blocking tools do not allow JavaScript code to run on a webpage, or do not allow requests for JavaScript files that do not originate from the Internet domain of the webpage that the end-user device is currently visiting. As nearly all Internet-based advertising, tracking networks, and web analytics providers are currently dependent on JavaScript files being loaded and run from outside the Internet domain that the end-user device is currently visiting, this method can be effective at blocking them.

Blocking tools can prevent the application on the end-user device from connecting to the servers of the ad networks and web analytics providers. This can be accomplished in many forms such as software on the end-user device (e.g. specialized web browsers, browser extensions, and browser windows embedded within other applications), VPNs and Internet proxies through which web browser requests from the end-user device pass, or by remapping DNS requests for the IP addresses of these servers to IPs that do not correspond with the requested supplemental content. Each of these methods interferes with the proper loading of ad content and web analytics packages, resulting in blocked ad content and muddled or non-existent web analytics for any end user using a blocking tool.

The domain names identified herein below were selected as exemplary and any matching of domain names actually in use is purely coincidental.

The following system and method for transforming online content may be used to circumvent content blocking by the aforementioned blocking tools by transforming portions of a webpage to obfuscate the inclusion of supplemental content within the webpage. By transforming portions of the webpage, the detection of the supplemental content within the webpage is hindered.

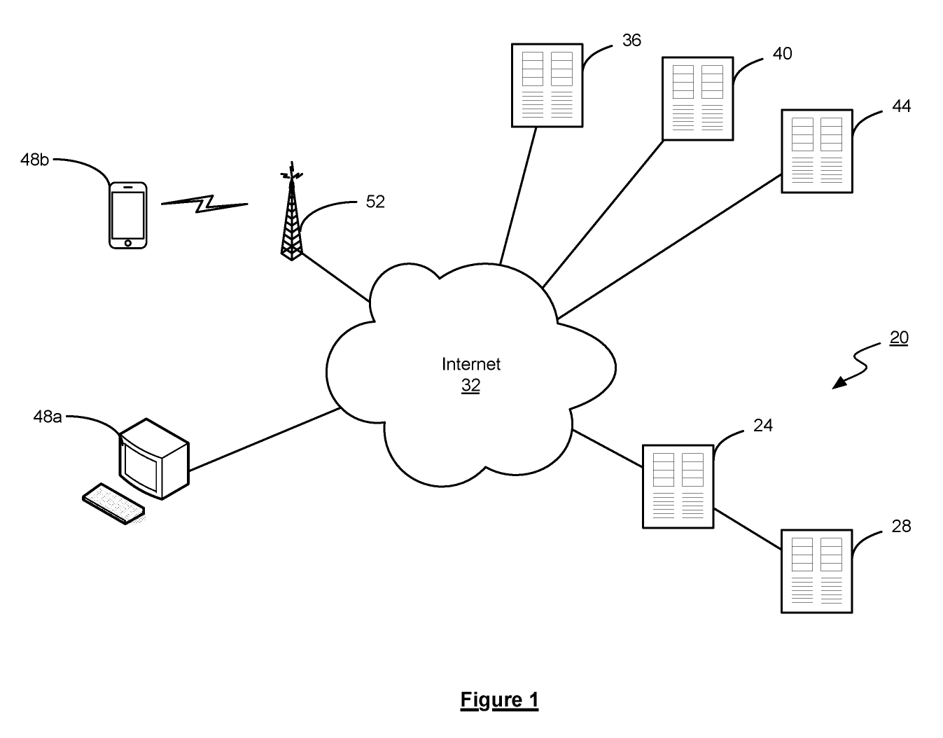

A system 20 for transforming online content in accordance with an embodiment and its operating environment is shown in FIG. 1. System 20 delivers ad content and web analytics resources in such a way that they are indiscernible from the remainder of a webpage's content, and therefore undetectable to blocking tools. Ad content and web analytics resources are transformed to have a unique set of identifying attributes for each webpage request, rendering the identification of the same ad content or web analytics resources across multiple page requests very difficult without actually downloading the content. Consequently, adding content transformed in this manner to a “public blacklist” of blocked content can be less effective, since the set of attributes that could be used to identify that content as ad/analytics content is unique for each page which passes through the system 20.

System 20 includes a transformation server 24 that is in communication with a web server computer 28 in a data center of a publisher. Transformation server 24 is, in this embodiment, a server computer system that is coupled to a computer network, which can be a public or private network. In the illustrated embodiment, the computer network is the Internet 32. A public addressing space referred to as the domain name system (“DNS”) is employed over Internet 32 and uses geographically distributed public DNS servers to translate user-friendly domain names, such as neatonews.com, to numeric Internet Protocol (“IP”) addresses that are used to route communications over Internet 32. The DNS servers have been configured to resolve a domain, neatonews.com, to a server in the data center that then routes requests for web pages through the transformation server 24 to the web server computer. It will be understood that the same can be performed for a subdomain, such as news.neatonews.com. In this manner, transformation server 24 acts as a proxy for web server computer 28. A “proxy” is a server (a computer system or an application) that acts as an intermediary for requests from clients seeking resources from other servers.

Web server computer 28 is an HTTP server that generates and serves webpages for the domain neatonews.com. The webpages are generated using a set of generally static templates at least partially populated by static and/or dynamic content, both of which are stored by web server computer 28. The generally static templates, the static content, and dynamic content used by web server computer 28 to generate webpages collectively are referred to as primary content. The templates define the general layout of the neatonews.com website and its webpages, and the dynamic content includes news story and headline text, accompanying images, video, etc.

The webpages generated by web server computer 28 includes references to supplemental content that is generated and served by other servers for inclusion in the webpage. In particular, the supplemental content includes ad content from an ad network server 36, tracking data from a tracking server 40, and web analytics scripts from a metrics server 44. Supplemental content stored by the ad network server 36 is accessible via its domain name, adnetwork.com. For example, an ad image could have a URL such as http://www.adnetwork.com/513a/image.jpg. Supplemental content stored by the tracking server 40 is accessible via its domain name, datatracker.com. For example, a tracker resource could have a URL such as http://www.datatracker.com/tracker.gif. Supplemental content stored by the metrics server 44 is accessible via its domain name, metrics.com. For example, a web analytics script could have a URL such as http://www.metrics.com/e/measure.js. While, in the illustrated example, only one ad network server 36, tracking server 40, and metrics server 44 are shown, it will be appreciated that more than one of any of these servers may be employed, and that they may be clustered or located at more than one geographic/network location and operated by more than one provider.

End-users access content served by web server computer 28 via end-user devices. A first end-user device 48a shown is a desktop computer that is coupled to Internet 32. A second end-user device 48b shown is a smartphone that is coupled to Internet 32 via cellular communications with a wireless carrier 52 and its infrastructure. End-user devices 48a, 48b (generically, “end-user device 48”) may employ blocking tools to block the retrieval of ad content, and web analytics and tracking artifacts such as third-party cookies and scripts.

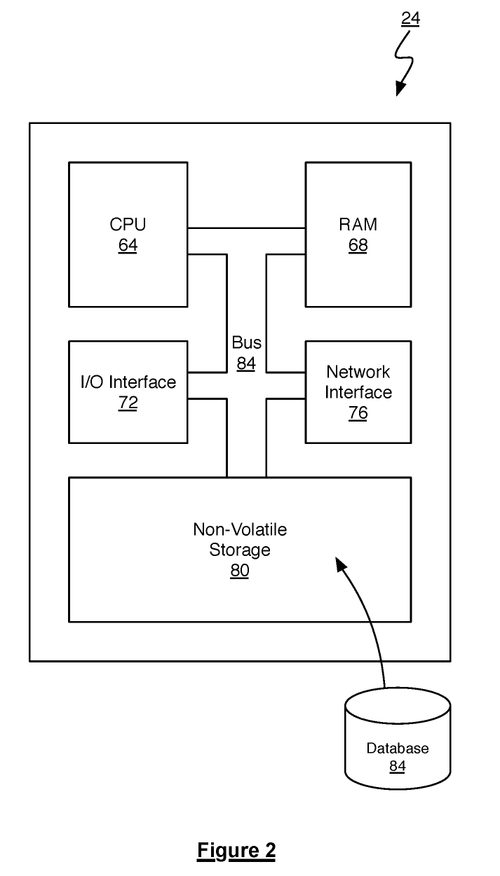

FIG. 2 shows various physical elements of transformation server 24. As shown, transformation server 24 has a number of physical and logical components, including a central processing unit (“CPU”) 64, random access memory (“RAM”) 68, an input/output (“I/O”) interface 72, a network interface 76, non-volatile storage 80, and a local bus 84 enabling CPU 64 to communicate with the other components. CPU 64 executes an operating system, a web service, a primary content transformation service, and a supplemental content transformation service. The primary content transformation service transforms primary content. The supplemental content transformation service retrieves and stores supplemental content resources from external servers and transforms them to correspond with transformations made to the primary content. The term “transformation service” may be used hereinafter to refer to some of the functions provided by the primary content transformation service and/or the supplemental content transformation service. RAM 68 provides relatively responsive volatile storage to CPU 64. I/O interface 72 allows for requests to be received from one or more devices, such as a keyboard, a mouse, etc., and outputs information to output devices, such as a display and/or speakers. Network interface 76 permits communication with other systems, such as end-user devices 48a, 48b and web server computer 28. Non-volatile storage 80 stores the operating system and programs, including computer-executable instructions for implementing the primary content transformation service and the supplemental content transformation service, as well as any data used by these services. This data includes mappings between the original locations of supplemental content and the revised locations of the supplemental content after transformation that are stored in a database 84. During operation of transformation server 24, the operating system, the programs and the data may be retrieved from non-volatile storage 80 and placed in RAM 68 to facilitate execution.

Transformation server 24 acts to transform web content with the result that supplemental content becomes substantially undetectable by the aforementioned blocking tools. As a publisher's content passes through the transformation server 24, it is obfuscated such that its attributes are uniquely altered for each webpage or API request, preventing these blocking tools from being able to identify which content to block.

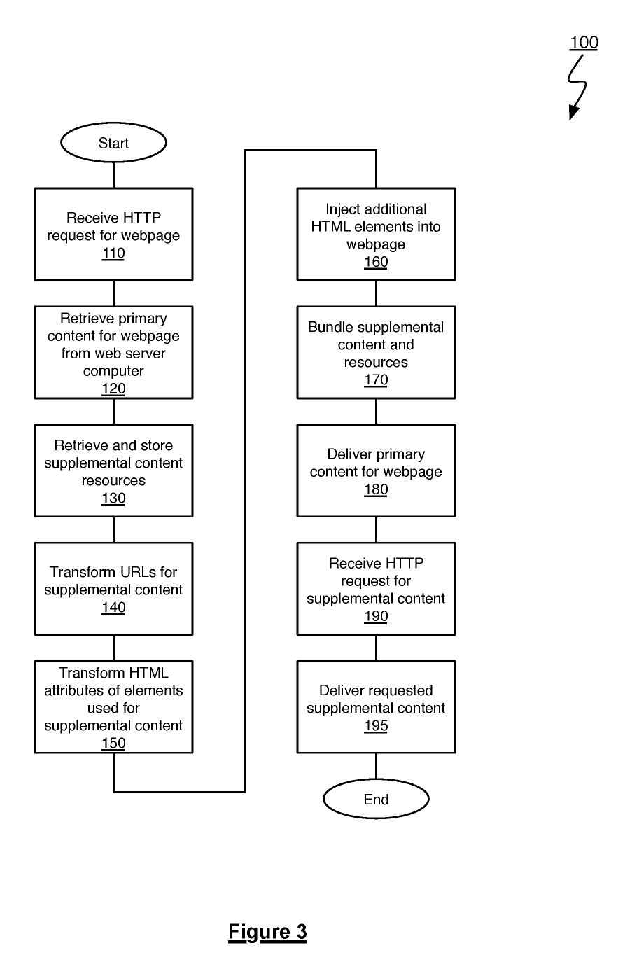

A method 100 of transforming online content using system 20 will now be described with reference to FIGS. 1 and 3. Method 100 commences with the receipt of an HTTP request for a webpage from end-user device 48 (110). For example, the request may be for the home webpage for neatonews.com, denoted by the URL http://www.neatonews.com/. The webpage requested is one whose primary content is generated by the web server computer 28. The DNS resolution of the URL has directed end-user device 48 to send its HTTP request to a computer in the data center, which then routes the request to transformation server 24. Upon receiving the HTTP request, transformation server 24 retrieves the primary content for the requested webpage from web server computer 28 (120). Transformation server 24 passes the HTTP request to web server computer 28 with little or no modification. The header of the HTTP request may be slightly modified to ask for content that is more readily obfuscated. For example, the HTTP request can be modified to request uncompressed content; that is, content that is not gzipped or the like. Web server computer 28 is not modified for use with system 20, and simply generates the webpage from a template and content that it has access to. The template and/or the content specifies instructions for the inclusion of supplemental content in the webpage. This includes its location in the page, how it is displayed, where the content can be obtained from by end-user device 48 (i.e., the URL of the content), etc. The generated webpage is then returned to transformation server 24.

Upon receiving the webpage from web server computer 28, some or all of the supplemental content resources to which the untransformed URLs pointed, as well as other resources used to render the webpage such as JavaScript, CSS, and images, are downloaded from ad network server 36, tracking server 40, and metrics server 44 and stored locally by transformation server 24 so that they are available when requested, if they have not previously been downloaded (130).

Transformation server 24 then transforms URLs for supplemental content referenced by the webpage for inclusion therein (140). The URLs for supplemental content in the webpage are transformed so that they originate from an endpoint within the Internet domain (that is, neatonews.com). The transformed URLs for supplemental content are generated to be unique to each request received by transformation server 24. Transformation server 24 registers the mappings between the new unique transformed URLs and the locations of the corresponding supplemental content previously downloaded and stored at 130 in database 84.

Because most blocking tools block or prevent requests made to certain domains, these blocking tools are not configured to block any content which originates from the publisher's own domain or any domain that publisher relies upon for page resources. If these blocking tools were to block content from the publisher's own domain, or any domain where content critical to the loading of the page is stored, it would have the undesired effect of making the publisher's website or application either unviewable or effectively useless due to the lack of critical resources needed for its proper rendering. This would defeat the purpose of using a blocking tool, since most end-users of blocking tools use them not for the purpose of making a publisher's content inaccessible, but to remove ad content from the pages of the publishers whose content they wish to consume.

Transformation server 24 then transforms HTML attributes of elements in the webpage used for supplemental content (150). The HTML attributes (id, class, style, etc.) of elements that are used for ad content, web analytics packages, and tracking functionality are transformed so that blocking tools cannot specifically identify them. This includes transforming those attributes such that they are unique for each new webpage request. An HTML attribute is a modifier of an HTML element. An attribute either modifies the default functionality of an element type, identifies it uniquely or as part of a class of other elements, or provides functionality to certain element types that are unable to function correctly without them.

Additional HTML elements are injected into the webpage by transformation server 24 (160). Transformation server 24 injects additional HTML elements that do not affect the visual layout of the content, but change the ability of the blocking tools to uniquely identify ad content, web analytics packages, and tracking components.

Supplemental content and resources are then bundled by transformation server 24 (170). Bundling outside content and resources (e.g., JavaScript and CSS files) together such that they cannot be readily identified by blocking tools, and additional resources—which enable ad content and web analytics—can be injected in. That is, ad content, and web analytics resources, and metrics components onto other requests that cannot be blocked without affecting the functionality of the webpage or application.

Primary content for the webpage is then delivered to end-user device 48 from transformation server 24 (180). The primary content retrieved by transformation server 24 from web server computer 28 at 120 and transformed by transformation server 24 is relayed to end-user device 48.

When the web browser or the like executing on end-user device 48 receives and parses the primary content, additional primary content that is not delivered with the webpage may be identified for downloading by the web browser. The end-user device 48 retrieves these additional primary content elements from transformation server 24. In addition, supplemental content to be inserted into the webpage is identified by the web browser on end-user device 48 and requested from transformation server 24 (190).

Transformation server 24 then returns the requested supplemental content to end-user device 48 (195). The requested supplemental content resources are not matched by name and/or location on transformation server 24. In order to satisfy the request, transformation server 24 references the mappings in database 84 between the new unique transformed URLs and the locations of the corresponding supplemental content previously downloaded and stored by transformation server 24 at 130. Using these mappings, transformation server 24 retrieves the stored supplemental content resources corresponding to the requested supplemental content resources, and transforms them to correspond to the unique transformed URLs. This may include renaming the supplemental content resources, bundling them together, etc. After transformation, the supplemental content resources match the names in the corresponding transformed URLs in the webpage delivered to end-user device 48 at 180. Once transformed, transformation server 24 returns the requested supplemental content resources to end-user device 48. Transformation server 24 then reports metrics and tracking data back to the appropriate supplemental servers regarding supplemental content that has been served on their behalf so that they may maintain view metrics, tracking data, etc.

After reporting back to the supplemental server(s), the method 100 is complete.

By varying the source of the supplemental content, its name, its attributes identified in the webpage, the layout of the webpage (through the addition of non-displaying elements), and/or how it's delivered (via bundling), system 20 transforms online content such that the supplemental content can be rendered virtually undetectable by blocking tools, even ones that employ heuristic approaches.

It is noted that, while in the above-described embodiment, transformation server 24 is a proxy server through which HTTP requests are routed within the data center, it will be understood that transformation server 24 may be a service that executes on web server computer 28 to intermediate HTTP requests.

Alternatively, DNS resolution can be configured to resolve the domain name neatonews.com to transformation server 24, which can then pass on requests to web server computer 28. In this manner, transformation server 24 can be a connection point of the data center for HTTP traffic or can be moved outside the data center and communicate with web server computer 28 over a private network or a public network such as Internet 32 to retrieve primary content.

In order to illustrate the operation of system 20 described above, the transformation of online content will now be described for a sample webpage or application.

Table 1 shows the body, or a portion thereof, of an HTML document for a home webpage for the website neatonews.com that includes ad content and web analytics packages before it has been transformed by transformation server 24. Sections of the code snippet below that are surrounded by the tags “<!-” and “-->” are included for the sole purpose of providing clarity to the reader (e.g., <!-- The following line of code executes a server request -->). Some of the URLs below are relative; that is, they do not begin with a domain or protocol (e.g. http://neatonews.com). These are requests to the webpage's own domain, neatonews.com. For example, if you view a web page or application at the URL “http://neatonews.com”, and that page utilizes an outside resource such as a style sheet linked to “/style.css”, then the full URL for that resource is “http://neatonews.com/style.css”.

```
TABLE 1
<html>
  <head>
    <!-- The following originates from the publisher's domain -->
    <style type=‘text/css’ src=‘/style.css’/>
    <script src=‘/main.js’/>
    <!-- The following originates from the domain of the ad provider -->
    <script src=‘http://adnetwork.com/adtool.js3’/>
    <!-- The following originates from the domain of the web analytics provider -->
    <script src=‘http://metrics.com/webanalytics.js’/>
  </head>
  <body>
    <h1>Example Title</h1>
    <p style=‘articleText’>
      Lorem ipsum dolor sit amet, consectetur adipiscing elit.
    </p>
    <!-- This is an image related to the article -->
    <img src=‘/article_name/image.jpg’/>
    <p style=‘articleText’>
      Ut enim ad minim veniam, quis nostrud exercitation ullamco.
    </p>
    <!-- This is an inline ad -->
    <a href=‘http://adnetwork.com/ad_click_through?track_id=123abc’>
      <img id=‘ad’ src=‘http://adnetwork.com/ads/98765.jpg’/>
    </a>
    <!-- This is an ad injected by JavaScript that originated from the ad network -->
    <iframe id=‘iframeAd’ src=‘http://adnetwork.com/iframe.html’>
      <!-- This is the source from the above URL -->
      <html>
        <body>
          <!-- The following are http requests used to read and write cookie data -->
          <img src=‘http://datatracker.com/cookie_drop.gif’/>
          <img src=‘http://datatracker.com/cookie.png’/>
          <!-- This is iframe's ad -->
          <a href=‘http://adnetwork.com/ad_click_through?track_id=123abc’>
            <img id=‘ad’ src=‘http://adnetwork.com/ads/98765.jpg’/>
          </a>
        </body>
      </html>
    <frame>
  </body>
</html>
```

As noted above, the HTML document forming the basis for the webpage include explicit references to content hosted on other Internet domains that are readily identifiable as being ad networks, web analytics providers, and tracker providers.

Shown in the below Table 2 is the same portion of the HTML document after it has been transformed by transformation server 24 to allow ad content and web analytics packages to penetrate the blocking tools. As transformation server 24 acts as a proxy server for web server computer 28, all the ad content and web analytics packages can be rerouted through the neatonews.com domain. That is, transformation server 24 can intercept requests to transformed URLs and fulfill them.

```
TABLE 2
<html>
  <head>
    <!-- The following originate from the publisher's domain -->
    <style type=‘text/css’ src=‘/cat/pig/dog.css’/>
    <!-- The publisher's JavaScript, as well as the JavaScript for ads
      and web analytics is now one combined package from the publisher's domain-->
    <script src=‘/moo/bin/cow.js’/>
  </head>
  <body>
    <h1>Example Title</h1>
    <p style=‘articleText’>
      Lorem ipsum dolor sit amet, consectetur adipiscing elit.
    </p>
    <!-- This is an image related to the article -->
    <img src=‘/article_name/image.jpg’/>
    <p style=‘articleText’>
      Ut enim ad minim veniam, quis nostrud exercitation ullamco.
    </p>
    <!-- This is an inline ad, padding elements are added to confuse blockers -->
    <div id=‘rainsnow’>
      <span style=‘bobcat’>
        <a href=‘/bin/img/test’>
          <img id=‘cowpig’ src=‘/cgi/css/js.jpg’/>
        </a>
      </span>
    </div>
    <!-- Ad injected by JavaScript that originated from the publisher's domain -->
    <iframe id=‘dogman’ src=‘/java/test/user.html’>
      <!-- This is the source from the above URL -->
      <html>
        <body>
          <!-- This is iframe's ad -->
          <a href=‘/bin/img/test’>
            <img id=‘woofmeow’ src=‘/cgi/css/js.jpg’/>
          </a>
        </body>
      </html>
    <frame>
  </body>
</html>
```

As noted when comparing the body of the HTML document before and after transformation, URLs pointing to the webpage's content, ad and web analytics resources have been changed to route through the publisher's domain (i.e., neatonews.com). Note the underlined attributes in the example below in Table 3. Here, the URL for an ad is transformed to originate from the same domain as the cascading style sheet, which determines how a webpage is rendered by a web browser or the like, and the URLs of both have been obfuscated through transformation:

TABLE 3

```
Before:
      <style type=‘text/css’ src=‘/style.css’/>
      <img id=‘ad’ src=‘http://adnetwork.com/ads/98765.jpg’/>
After:
      <style type=‘text/css’ src=‘/cat/pig/dog.css’/>
      <img id=‘cowpig’ src=‘/cgi/css/js.jpg’/>
```

Attributes that could identify ad content, tracker artifacts, and web analytics packages have been randomly changed to be unique for each end-user device (or even each session, where an end-user device has more than one session active for the website). Note the underlined attributes in the example in Table 4

TABLE 4

```
Before:
      <img id=‘ad’ src=‘http://adnetwork.com/ads/98765.jpg’/>
After:
      <img id=‘cowpig’ src=‘/cgi/css/js.jpg’/>
```

Additional elements that make it more difficult to uniquely identify ad content have been added during transformation. Note the underlined elements in Table 5.

```
TABLE 5
Before:
<a href=‘http://advertiser.com/ad_click_through?track_id=123abc’>
  <img id=‘ad’ src=‘http://adnetwork.com/ads/98765.jpg’/>
</a>
After:
<div id=‘rainsnow’>
  <span style=‘bobcat’>
    <a href=‘/bin/img/test’>
      <img id=‘cowpig’ src=‘/cgi/css/js.jpg’/>
    </a>
  </span>
</div>
```

Page resources, such as JavaScript and CSS, have been bundled together with resources related to ad content, tracking artifacts, and web analytics packages and routed through the publisher's domain, making them difficult to block without damaging the rendering the primary content of the webpage). Further obfuscation is shown in Table 6.

```
TABLE 6
Before:
      <!-- The following originates from the publisher's domain -->
      <style type=‘text/css’ src=‘/style.css’/>
      <script src=‘/main.js’/>
      <!-- The following originates from the domain of the ad provider -->
      <script src=‘http://adnetwork.com/adtool.js’/>
      <!-- The following originates from the domain of the web analytics provider -->
      <script src=‘http://metrics.com/webanalytics.js’/>
After:
      <!-- The following originates from the publisher's domain -->
      <style type=‘text/css’ src=‘/cat/pig/dog.css’/>
      <!-- The publisher's JavaScript, as well as the JavaScript for ads and web analytics is now
      one combined package -->
      <script src=‘/moo/bin/cow.js’/>
```

In the above exemplary HTML, natural language transformations have been used to obfuscate unique identifiers to supplemental content. However, randomly-generated alphanumeric strings can be used alternately to obfuscate unique identifiers. An example of both types of transformations is shown in Table 7.

```
TABLE 7
Before:
            <img id=‘ad’ src=‘http://adnetwork.com/carad.png’/>
After natural language transformation:
            <img id=‘cowpig’ src=‘/dog/man/cat/’/>
After randomly generated alphanumeric string transformation:
            <img id=‘a7h3k86kj’ src=‘/j38d876h/83hjf745h/’/>
```

In the embodiment illustrated in FIG. 1 and described above, transformation server 24 retrieves, stores, and serves supplemental content. It may be desirable in some cases to have other servers perform this function.

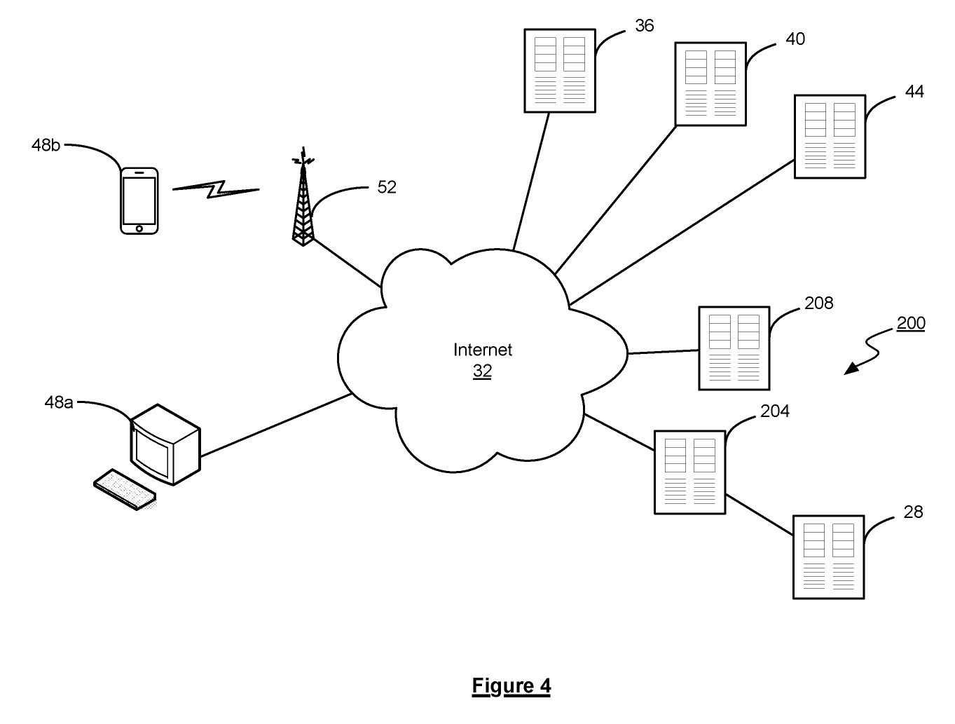

FIG. 4 shows a system 200 for transforming online content in accordance with another embodiment. System 200 includes a transformation server 204 and a supplemental content aggregation server 208. Transformation server 204, like transformation server 24 of FIG. 1, acts as a proxy for web server computer 28.

Supplemental content aggregation server 208 performs the function of caching and serving supplemental content retrieved from ad network server 36, tracking server 40, and metrics server 44. A DNS entry for either a subdomain of the publisher, such as cdn.neatonews.com, or for a separate domain or subdomain, such as cdn.blockthrough.com, can be made for supplemental content aggregation server 208, thus obfuscating supplemental content that it serves. The transformed URLs for supplemental content generated by transformation server 204 are fully qualified; for example, ‘http://cdn.blockthrough.com/cat/pig/dog.css’. As a result, the transformed Internet domain is distinct from ad network server 36, tracking server 40, and metrics server 44. It will be understood that a set of distributed supplemental content aggregation server 208 can be used for the fast retrieval of page resources.

Transformation server 204 transforms HTML documents served by web server computer 28 much in the same way as identified above, except that it modifies URLs for supplemental content to reference supplemental content aggregation server 208. Further, database 84 containing the mappings between the generated unique URLs for the supplemental content and the URLs of the supplemental content on ad network server 36, tracking server 40, and metrics server 44 is synchronized with a similar database maintained by supplemental content aggregation server 208.

When a web browser on an end-user device 48 requests the primary content of a webpage after transformation by transformation server 204, it makes HTTP requests to supplemental content aggregation server 208 for the supplemental content. Supplemental content aggregation server 208 uses the mappings provided by transformation server 204 to translate the supplemental content URLs received from end-user device 48 and retrieve the supplemental content from ad network server 36, tracking server 40, and metrics server 44. Supplemental content aggregation server 208 then transforms the supplemental content as indicated by the mappings by renaming, bundling, etc. and provides it to end-user device 48. The supplemental content can be cached to improve responsiveness for future requests.

In some cases, it may be desirable to not have a separate computer system intercept requests directed to a web server computer. Instead, the functionality of a transformation server may be provided remotely on demand to the web server computer.

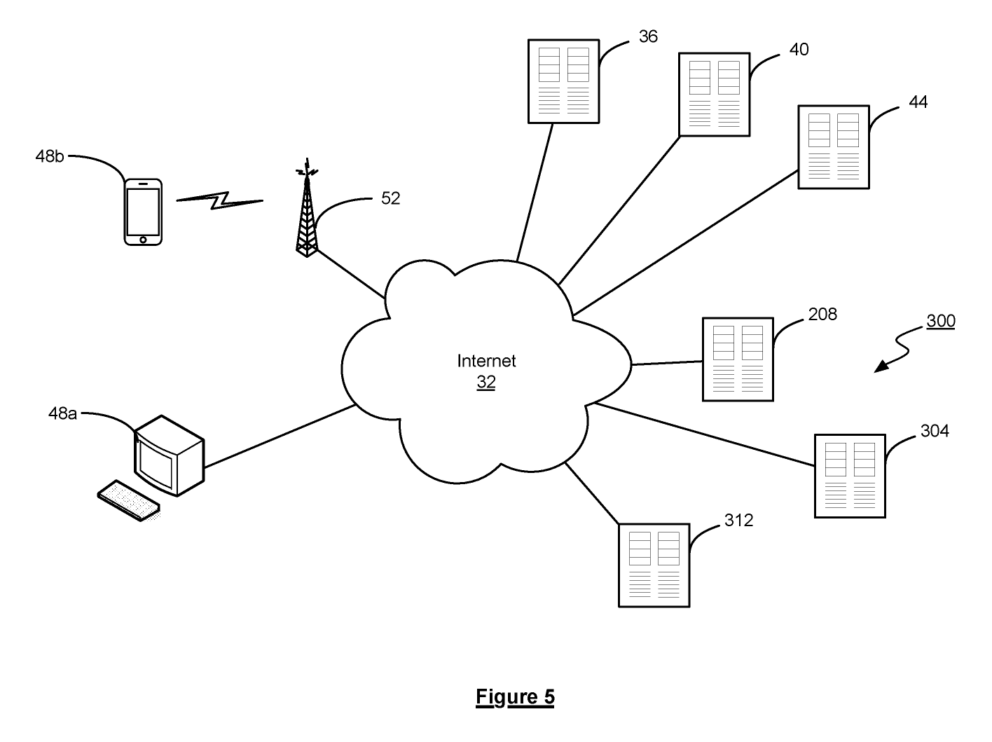

FIG. 5 shows a system 300 for transforming online content in accordance with a further embodiment. System 300 includes a transformation server 304 in communication with supplemental content aggregation server 208. Transformation server 304 implements a remote application programming interface (“API”) through which it receives primary content, such as HTML documents, as input. Upon receiving the primary content, transformation server 304 transforms them, much in the same way transformation server 204 does, and returns the transformed primary content as output. Database 84 of transformation server 304 containing the mappings between the generated unique URLs for the supplemental content and the URLs of the supplemental content on ad network server 36, tracking server 40, and metrics server 44 is synchronized with a similar database maintained by supplemental content aggregation server 208.

Alternatively, transformation server 304 could be configured to retrieve, cache, transform and serve supplemental content specified in primary content transformed for web server computer 312.

Web server computer 312 is similar to web server 28, except that it has been modified to transmit at least a portion of the primary content, including the base HTML document defining a webpage, to transformation server 304 via its remote API after generating it. Transformation server 304 transforms the primary content and returns it to web server computer 312. Upon receipt of the transformed primary content, web server computer 312 provides it to end-user 48.

In other embodiments, some or all of the functions of the primary content transformation service and the supplemental content transformation service can be executed on the web server computer. The primary content transformation service can either receive requests for webpages and pass them to the web server service or, alternatively, the web server service can pass primary content to the primary content transformation service for transformation via an API or the like before providing the webpage to an end-user device.

In order to further obfuscate the presence of supplemental content in a webpage, the primary content may also be obfuscated using some of the same approaches identified above for obfuscating supplemental content. For example, images and other webpage elements may be renamed uniquely for each copy of the webpage served, and served by another server to which a subdomain or other domain is mapped. By also making the primary content unpredictable within a webpage, it becomes harder to distinguish supplemental content from primary content.

Computer-executable instructions for implementing parts or all of the transformation service on a computer system could be provided separately from the computer system, for example, on a computer-readable medium (such as, for example, an optical disk, a hard disk, a USB drive or a media card) or by making them available for downloading over a communications network, such as the Internet.

While the transformation server, the web server computer, and the supplemental content aggregation server are shown as single physical computers in the above-described embodiments, it will be appreciated that these servers can also include two or more physical computers in communication with each other. Accordingly, while evident from the descriptions of the above-described embodiments, the transformation server's components can reside on the same physical computer or on separate physical computers, and some or all of the components may reside on the web server computer. In such implementations where there is more than one transformation server and/or supplemental server, the mapping database can be replicated and/or shared amongst the various servers, and possibly via a separate database server in some embodiments.

One or more portions of the method may be executed by separate parties. For example, the transformation service and the supplemental content aggregation service may be provided by different parties.

In some cases, it may be beneficial to regenerate some of the supplemental content so that it may be readily served by other computers. For example, supplemental content resources can include JavaScript code that has hardcoded URLs for supplemental servers. In another example, CSS selectors may be modified to reference the appropriate elements of a webpage, after obfuscation, to be styled. Such resources can be modified to include soft references or point to other servers where the supplemental content may be hosted, such as the transformation server.

It may be desirable to provide additional supplemental content via the transformation service. The transformation service can inject additional web analytics content, tracking content, and ad content. The data collected by this injected content may be shared with other supplemental servers.

In a further embodiment of the above system and method, a tag-based implementation may be used by including a JavaScript file in the header of the online content. The JavaScript can be used as a mechanism for calling to the proxy server and initiating its functions, as described herein. The JavaScript file can either be loaded from a first-party domain or a third-party domain. Preferably, the third-party domain is one that appears innocuous. Whereby the first-party domain can be, for example, from the publisher's or web server's own domain; and the third-party domain can be, for example, a domain that appears to be a Content Delivery Network (CDN). The CDN domain can be used as opposed to JavaScript which runs third-party from the domain of an originating third party.

While the above-described embodiments are described with specificity to the Internet, those of skill in the art will appreciate that other networks can be employed.

Although the invention has been described with reference to certain specific embodiments, various transformations thereof will be apparent to those skilled in the art. The scope of the claims should not be limited by the preferred embodiments, but should be given the broadest interpretation consistent with the description as a whole.

1. A system for transforming online content between one or more web servers and an end-user computing device, the online content comprising primary content and supplemental content, the system comprising:
a transformation server comprising one or more processors and a data storage device communicatively linked to the one or more processors, the one or more processors executable to:
receive online content hosted by the one or more web servers;
transform portions of the online content to obfuscate the inclusion of the supplemental content among the primary content; and
transmit the online content having the transformed portions to the end-user computing device.

2. The system of claim 1, wherein the transformation server is a proxy intermediating communication between the web server and the end-user computing device.

3. The system of claim 1, wherein a Domain Name System (DNS) resolves a domain name of the web server hosting the supplemental content to that of the transformation server.

4. The system of claim 1, wherein the transformation server is executed on at least one of the one or more web servers.

5. The system of claim 1, wherein the transforming of portions of the online content comprises transforming a Uniform Resource Locator (URL) of the supplemental content to appear to originate from within a selected domain.

6. The system of claim 5, wherein the selected domain is a same or similar domain of the primary content.

7. The system of claim 5, wherein the selected domain is a domain that is determined by the transformation server to be not contained on a blacklist of advertisement providers.

8. The system of claim 5, wherein the transformed URL is generated to be unique for each subsequent transformation.

9. The system of claim 1, wherein the transforming of portions of the online content comprises transforming aspects of the HyperText Markup Language (HTML) elements or Cascading Style Sheet (CSS) elements of the supplemental content to confound identification of the supplemental content.

10. The system of claim 9, wherein the transforming of the HTML elements or CSS elements comprises obfuscating HTML identifiers or CSS identifiers unique to the supplemental content.

11. The system of claim 9, wherein the transforming of the HTML elements or CSS elements is unique for each subsequent transformation.

12. The system of claim 9, wherein the transforming of portions of the online content further comprises injecting additional visually-neutral HTML elements or CSS elements into the online content to confound identification of the supplemental content.

13. The system of claim 9, wherein the transforming of portions of the online content further comprises transforming aspects of the HTML elements or CSS elements of the primary content to confound identification of the supplemental content from the primary content.

14. The system of claim 1, wherein the transforming of portions of the online content comprises bundling supplemental content with resources required to visually render the primary content.

15. The system of claim 1, wherein the one or more processors are further executable to:
map the transformed portions of the online content to the respective portions of the online content prior to transformation;
store the transformed portions of the online content;
receive a request from the end-user computing device for at least one of the said portions of the online content; and
use the mappings, retrieving the transformed portions of the online content corresponding to the requested portions of the online content.

16. The system of claim 1, wherein the transforming of portions of the online content comprises injecting additional supplemental content from an alternate source.

17. The system of claim 1, wherein communication with the transformation server is initiated by a JavaScript file in the header of the online content.

18. A method for transforming online content between a web server and an end-user computing device, the online content comprising primary content and supplemental content, the method comprising:
receiving online content from the web server;
transforming transform portions of the online content to obfuscate the inclusion of the supplemental content among the primary content; and
transmitting the online content having the transformed portions to the end-user computing device.

19. The method of claim 18, wherein the transforming of portions of the online content comprises transforming a Uniform Resource Locator (URL) of the supplemental content to appear to originate from within a selected domain.

20. The method of claim 18, wherein the selected domain is a same or similar domain of the primary content.

21. The method of claim 18, wherein the selected domain is a domain that is determined to be not contained on a blacklist of advertisement providers.

22. The method of claim 18, wherein the transformed URL is generated to be unique for each subsequent transformation.

23. The method of claim 18, wherein the transforming of portions of the online content comprises transforming aspects of the HyperText Markup Language (HTML) elements or Cascading Style Sheet (CSS) elements of the supplemental content to confound identification of the supplemental content.

24. The method of claim 18, wherein the transforming of portions of the online content further comprises injecting additional visually-neutral HTML elements or CSS elements into the online content to confound identification of the supplemental content.

25. The method of claim 18, wherein the transforming of portions of the online content comprises bundling supplemental content with resources required to visually render the primary content

26. The method of claim 18, wherein the transforming of portions of the online content comprises injecting additional supplemental content from an alternate source.

27. The method of claim 18, wherein communication with the transformation server is initiated by a JavaScript file in the header of the online content.

28. The method of claim 18, further comprising:
mapping the transformed portions of the online content to the respective portions of the online content prior to transformation;
storing the transformed portions of the online content;
receiving a request from the end-user computing device for at least one of the said portions of the online content; and
using the mappings, retrieving the transformed portions of the online content corresponding to the requested portions of the online content.
